(19) United States
(12) Patent Application Publication
(10) Pub. No.: US 2017/0142901 A1
(43) Pub. Date: May 25, 2017

(54) Leveraged Steering Articulation Joint for an Agricultural Harvesting Combine

(71) Applicant: Tribine Industries LLC, Logansport, IN (US)

(72) Inventors: Reinhold A. Herrman, Manhattan, KS (US); Robert A. Matousek, Valley Center, KS (US); Ben N. Dillon, Logansport, IN (US); Roger Claerhout, Hesston, KS (US)

(73) Assignee: Tribine Industries LLC, Logansport, IN (US)

(21) Appl. No.: 14/946,827

(22) Filed: Nov. 20, 2015

(51) Int. Cl. A01D 41/127; A01D 61/00; A01D 41/12; A01D 67/00

(52) U.S. Cl. CPC A01D 41/1272; A01D 67/005; A01D 61/008; A01D 41/1208

(57) ABSTRACT

A grain harvesting articulated combine includes of a crop processing power unit (PPU), a rear grain cart, and an articulation joint that connects the PPU with the rear grain cart. The articulation joint includes a transverse drawbar attached to the PPU about its rear, which has an aperture facing the rear grain cart and is located underneath the PPU forwardly of the rear of the powered PPU. An arcuate beam is attached to the rear of the powered PPU. A grain auger assembly runs from the PPU to the rear grain cart. The grain auger assembly has a forward end and a rear end and is formed from an outer tube and an inner tube rotatingly carried within the outer tube. A pin runs through the transverse drawbar aperture and a bracket aperture. A pair of articulation cylinders is affixed to the transverse drawbar and to the outer tube.

### CROSS-REFERENCE TO RELATED APPLICATIONS

None.

### STATEMENT REGARDING FEDERALLY SPONSORED RESEARCH

Not applicable.

### BACKGROUND

The present disclosure relates to harvesting combines and more particularly to articulated (jointed) combines employing, inter alia, a leveraged articulation joint with provision to measuring grain flow rate and a grain conduit to the rear module.

The subject of an articulated harvester, some of which are based on current commercial grain harvester designs, is disclosed in U.S. Pat. Nos. 4,317,326, 4,428,182, 6,012,272, 6,125,618, 6,339,917, 6,604,351, 6,606,844, 6,604,995, 6,604,350, 6,484,485, 6,612,101, 6,233,911, 6,240,711, 6,167,982, 7,553,228, 8,286,984, 8,292,008, and 8,435,104. A harvester/grain cart combination can be converted to an “articulated” combine as disclosed in U.S. Pat. No. 6,910,845. Various grain handling and grain unloading techniques are disclosed, inter alia, in U.S. Pat. Nos. 7,143,863 and 7,198,449. The disclosures of these patents are expressly incorporated herein by reference.

Most of the articulated combines cited above exhibit compromised design features due to the design basis being limited to current commercial grain harvester designs. For example, current commercial grain harvester designs have an onboard grain bin with the forward bogey along with grain heads, cleaners, etc. That does not make such designs faulty, as they represent a substantial advancement in the harvester art for manufactures that want to maintain current grain harvester architecture.

Current features for today's agricultural harvesters can be based on features disclosed in U.S. Pat. Nos. 8,286,984, 8,292,008, and 8,435,104.

An agricultural combine has multiple steering requirements. Precise control is needed as the row-harvesting units, such as a cornhead, are guided through the rows of grain. When the end of the field is reached, a tight turning radius is needed to proceed back across the field in order to harvest the crop immediately adjacent to the just-completed rows or round. Concomitant with its field performance, this large vehicle also must be controlled on the roadway at speeds of around 20 mph and around tight corners. Steering with the common rear wheel only steering configuration at higher road speeds often is unstable. Another steering associated problem is to turn multiple axle, heavily-loaded bogies with large tires in a tight radius while minimizing sliding the tires in the horizontal direction which places high stresses in the suspension, piles up dirt in the field, and causes excessive tire wear.

To date, no articulated combine is commercial. Clearly, there is a need for a practical articulated combine that can be commercialized.

### BRIEF SUMMARY

A grain harvesting articulated combine includes of a forward tractor or crop processing power unit (PPU), a rear grain cart, and an articulation joint that connects the PPU with the rear grain cart. The PPU has a front, a rear, and a centerline. The improved articulation joint includes a transverse drawbar attached to the PPU about its rear and about the PPU centerline. The transverse drawbar has an aperture facing the rear grain cart and is located underneath the PPU forwardly of the rear of the powered PPU. An arcuate beam is attached to the rear of the powered PPU. A grain auger assembly runs from the PPU to the rear grain cart for transferring clean grain to the rear grain cart. The grain auger assembly has a forward end and a rear end and is formed from an outer tube and an inner tube rotatingly carried within the outer tube. A bracket is affixed to the forward end of the grain auger assembly outer tube the bracket and has an aperture. A pin runs through the transverse drawbar aperture and through the bracket aperture. A pair of articulation cylinders is affixed to the transverse drawbar and to the grain auger assembly outer tube. A sliding member is slidably carried by the arcuate beam and is affixed to the grain auger assembly outer tube.

### BRIEF DESCRIPTION OF THE DRAWINGS

For a fuller understanding of the nature and advantages of the present method and process, reference should be had to the following detailed description taken in connection with the accompanying drawings, in which:

FIG. 1 is a side elevation view of an articulated combine having the disclosed grain cart;

FIG. 2 is an overhead view of the articulated combine of FIG. 1;

FIG. 3 is an isometric view of the articulated combine of FIG. 1;

FIG. 4 is an overhead top view of the articulated harvester with a crabbed rear grain cart;

FIG. 5 is an underneath isometric view of the articulated combine of FIG. 1 showing the leveraged articulation joint;

FIG. 5A is an exploded view of the leveraged articulation joint shown in FIG. 5;

FIG. 6 is a sectional view taken along line 6-6 of FIG. 2;

FIG. 6A is an exploded sectional view of the leveraged articulation joint shown in FIG. 6;

FIG. 7 is a sectional view taken along line 7-7 of FIG. 1;

FIG. 8 is an overhead view of just the leveraged articulation joint;

FIG. 9 is an overhead view of just the leveraged articulation joint in a steering position;

FIG. 10 is an isometric view of just the leveraged articulation joint;

FIG. 11 is another isometric view of just the leveraged articulation joint;

FIG. 12 is an isometric view of the articulated combine with the right rear wheel of the rear module raised, such as would occur when traveling over uneven ground;

FIG. 13 is a partial side view of the front and rear modules being pulled apart at the grain transfer tube of the leveraged articulation joint; and

FIG. 14 is an isometric view of the grain transfer tube of the leveraged articulation joint of FIG. 13.

The drawings will be described in greater detail below.

### DETAILED DESCRIPTION

The actual leveraged hinge joint will be located considerably forward of the rear of the front module and will be a pinned, hinged joint running through a substantial drawbar situation in the belly of the front module. The hitch tube then runs rearward past the rear end of the front module and then an additional distance to the front of the rear module.

At the rear of the front module and above the hitch tube will be a circular beam (bridge henceforth) attached at both sides of the lower rear of the front module, such that a sliding member attached to and above the tubular hitch can traverse the length of the bridge in a side-to-side motion as the hitch is moved side to side as the angle of articulation of the two modules is changed to effect steering of the vehicle.

Since the hitch is moving side-to-side relative to the components of the front module, the optimum location to inject grain flow into the auger within the hitch tube is necessarily at the front of the hitch, directly above the rotation focal point hinge pin. And further, since the grain flow must be at some high speed versus gravitation speed in a short fall, also disclosed is a mechanism that can accelerate the grain flow from a sideways horizontal motion of the collection auger under the cleaning system into a largely forward-horizontal motion that is then deflected into a large downward flow by deflecting off of an angle front wall of the hitch structure, while maintaining (now downwardly) velocity to allow it to inject between rapidly progressing auger flights within the tube hitch. Coincident to the front wall, is an impact sensor pad that is the flow rate, measuring device common to combine harvester grain elevators in the trade, although functioning in an upside-down orientation versus those sensor uses.

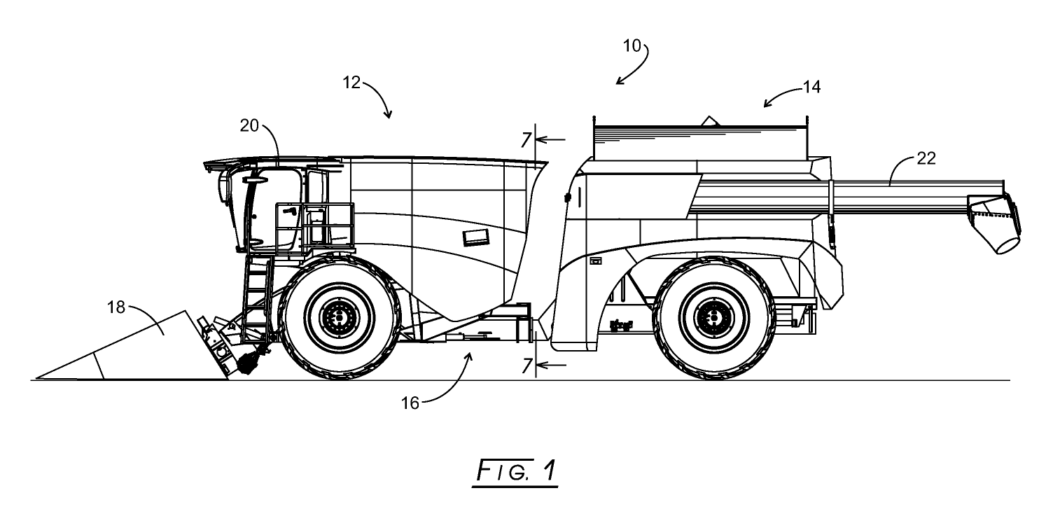

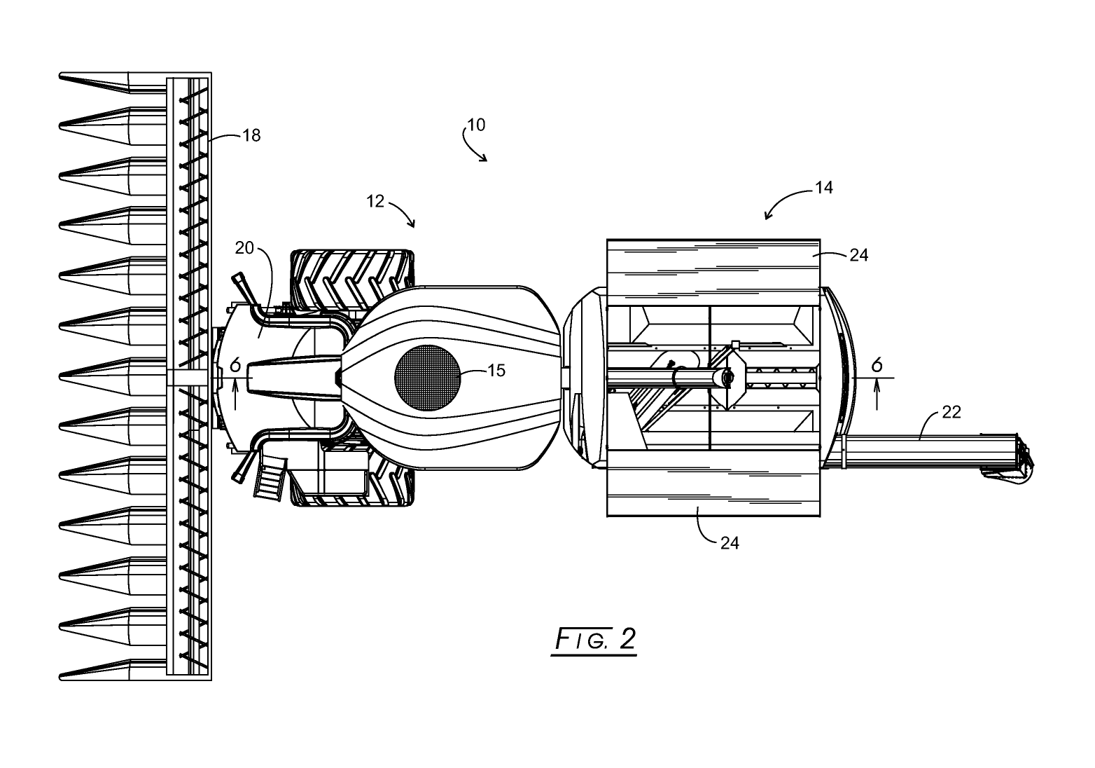

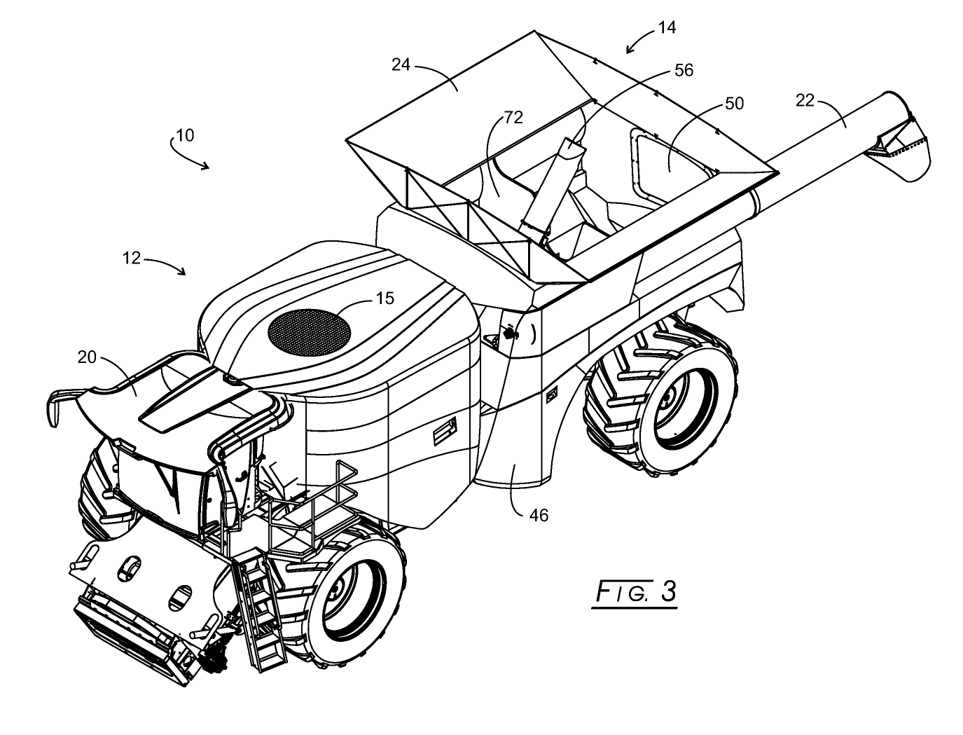

Referring initially to FIGS. 1, 2, 3, and 4, an articulated harvester, 10, consists of a powered PPU, 12, a rear grain cart, 14, and an articulation joint, 16, that connects PPU 12 with rear grain cart 14. The details of rear grain cart 14 are disclosed in commonly owned application Ser. No. ______ filed ______ (attorney docket DIL 2-028). PPU 12 carries a grainhead, 18, operator's cab, 20, grain cleaning and handling assembly (not shown), and engine (not shown). The grain cleaning and handling assembly in PPU 12 is disclosed in commonly owned application Ser. No. ______ filed ______ (attorney docket DIL 2-027). PPU 12 is devoid of any grain storage, such being exclusive in rear grain cart 14. While both PPU 12 and rear grain cart 14 are shown being carried by wheel assemblies, one or both could be tracked. A screened air inlet, 15, is located atop PPU 12.

An off-loading auger assembly, 22, is in the folded home position and being carried by rear grain cart 14. Grain cart 14 also bears a foldable roof, 24, shown in an open position, but which can fold inwardly to cover grain stored in rear grain cart 14. Foldable roof 24 may be made of metal, plastic, or other suitable material, but may be made of durable plastic for weight reduction and easy folding/unfolding. A grain storage bin, 28, (see also FIG. 14) carried by grain cart 14 may be made of plastic also in keeping with desirable weight reduction; although, it could be made of metal also at the expense of weight. All plastic parts may be filled with particulate or fiber reinforcement in conventional fashion and could be laminate in construction. Further details on rear grain cart 14 can be found in Ser. No. ______ (attorney docket DIL 2-028), cited above.

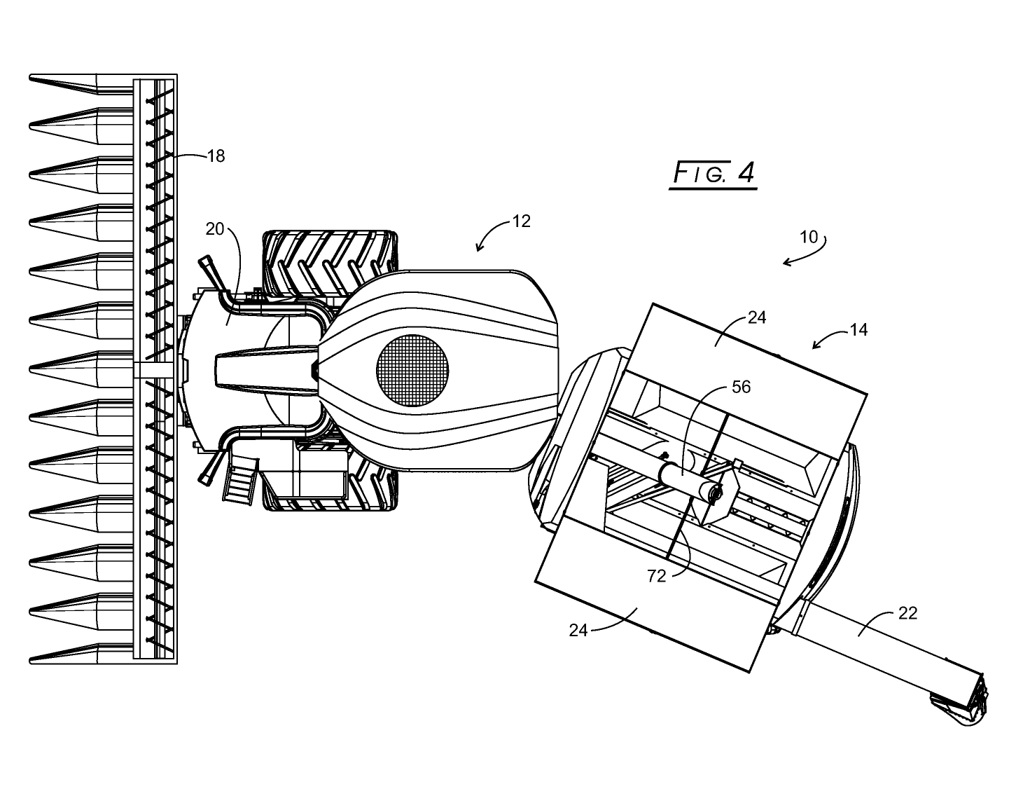

Referring to FIG. 4, rear grain cart 14 is in a crabbed position enabling it to move over closer to a grain semi-truck into which grain is dumped by off-loading auger assembly 22. Such grain unloading can be accomplished in the field while articulated harvester 10 still is harvesting grain and the grain semi-truck is driving next to it. Articulation joint assembly 16 disclosed herein enables the crabbing of rear grain cart 14.

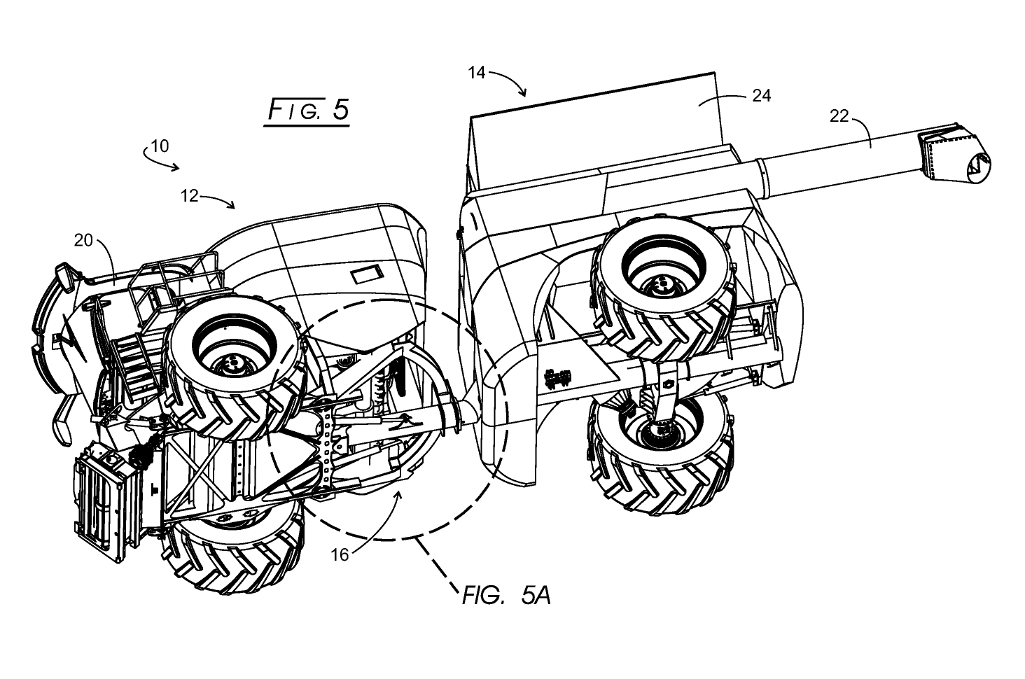

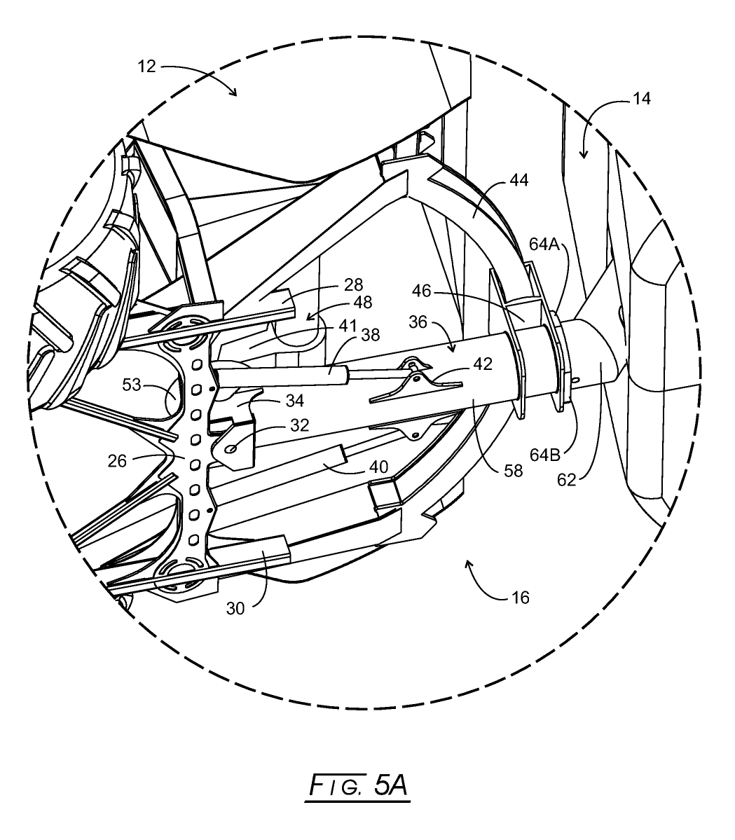

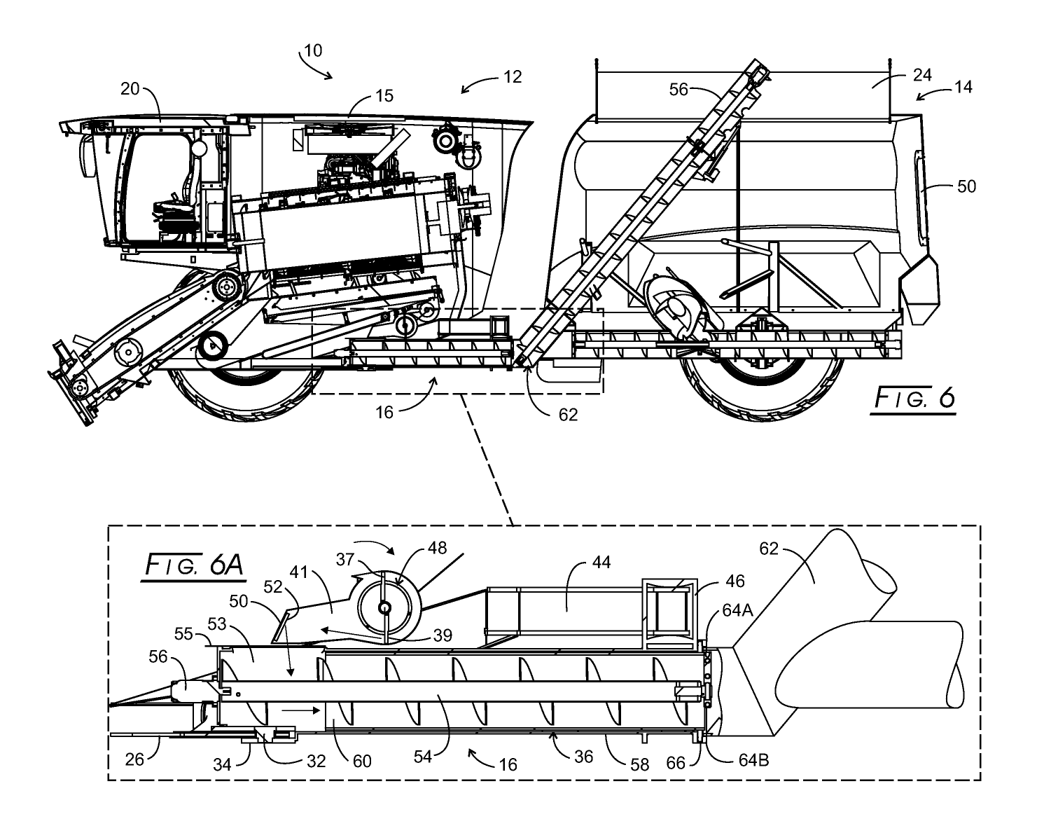

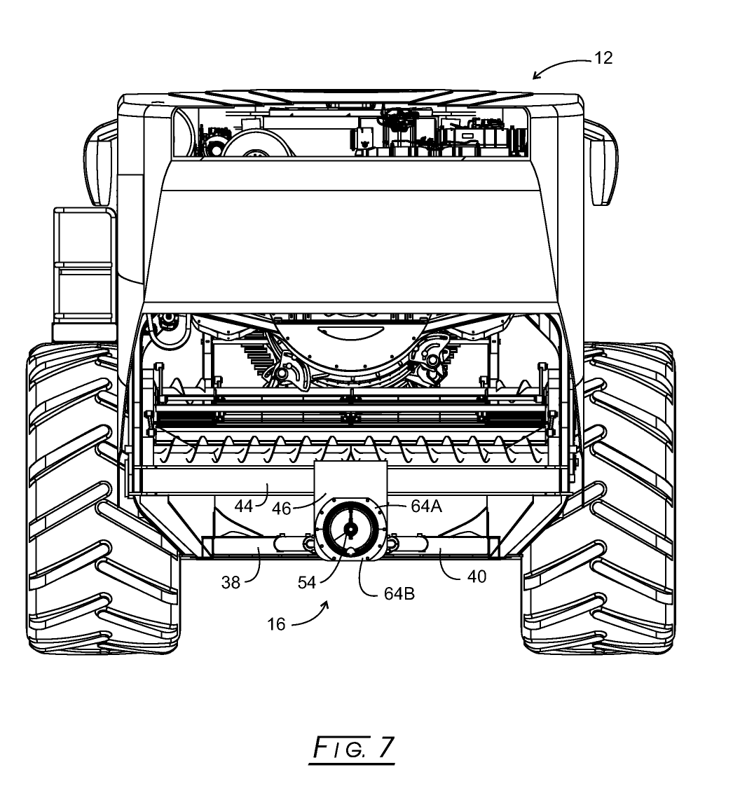

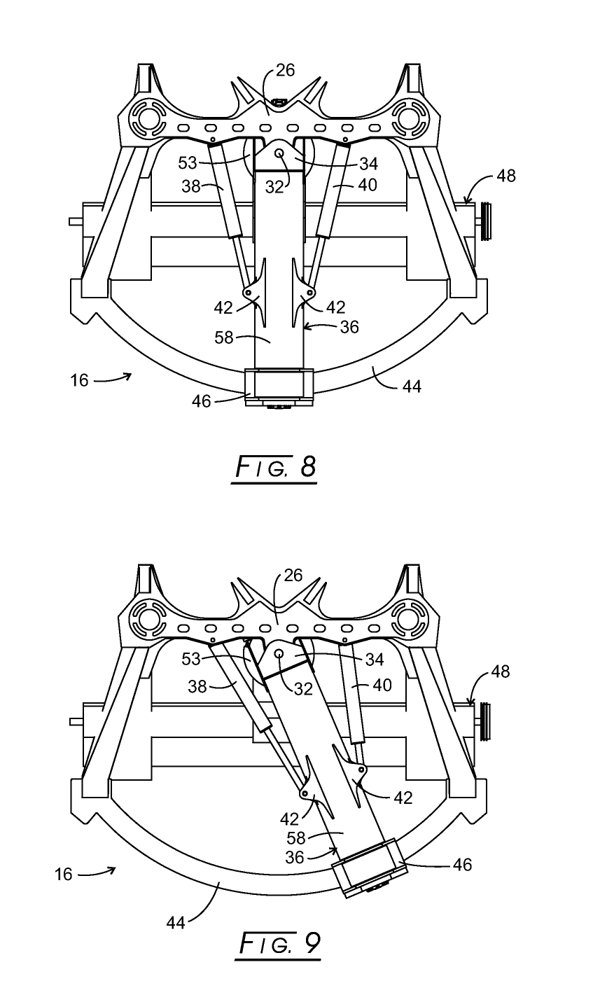

Referring to FIGS. 5 and 5A, articulation joint 16 is seen from its underneath side. Articulation joint 16 is located considerably forward of the rear of front module 12 almost to its center and is a pinned, pivoting joint running through a substantial drawbar situation in the belly of the front module. In particular, a drawbar, 26, spans transversely to the direction of travel of the combine and is centered about the centerline (front to back) of front module 12. Drawbar 26 is attached at either end to frame members, 28 and 30, which are in turn attached to front module 12 at its rear. Drawbar 26 has a forward aperture in which a pin, 32, (see FIG. 6A also) fits for attaching drawbar 26, to a C-flange, 34, which in turn is attached to a grain auger assembly, 36, which transfer clean grain from forward module 12 to rear grain cart 14.

A pair of articulation cylinder assemblies, 38 and 40, run from drawbar 26 to grain auger assembly 36 for steering articulated combine 10. These articulation assemblies attach to grain auger assembly 36 by bracket assemblies, such as a bracket assembly, 42 (see also FIG. 14), seen in FIG. 5A. An arcuate beam, 44, is attached to the rear of forward module 12 and carries a sliding member, 46, which in turn is affixed to grain auger assembly 36. When articulation cylinder assemblies 38 and 40 are actuated for turning combine 10, sliding member 46 slides on arcuate beam 44 to maintain grain auger assembly 36 in the same position relative to the front and rear modules for continuous feed of clean grain from front module 12 to rear module 14.

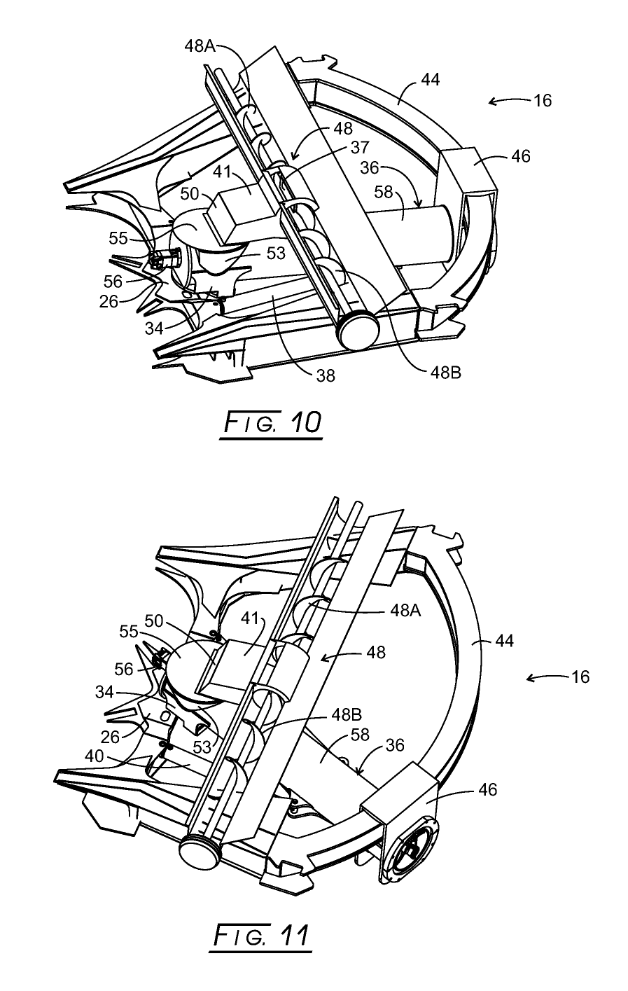

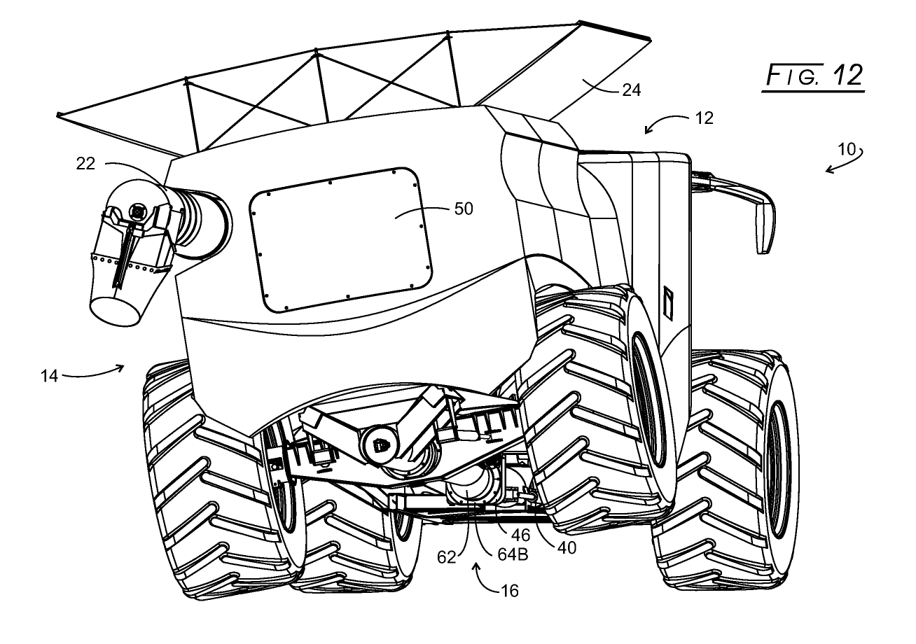

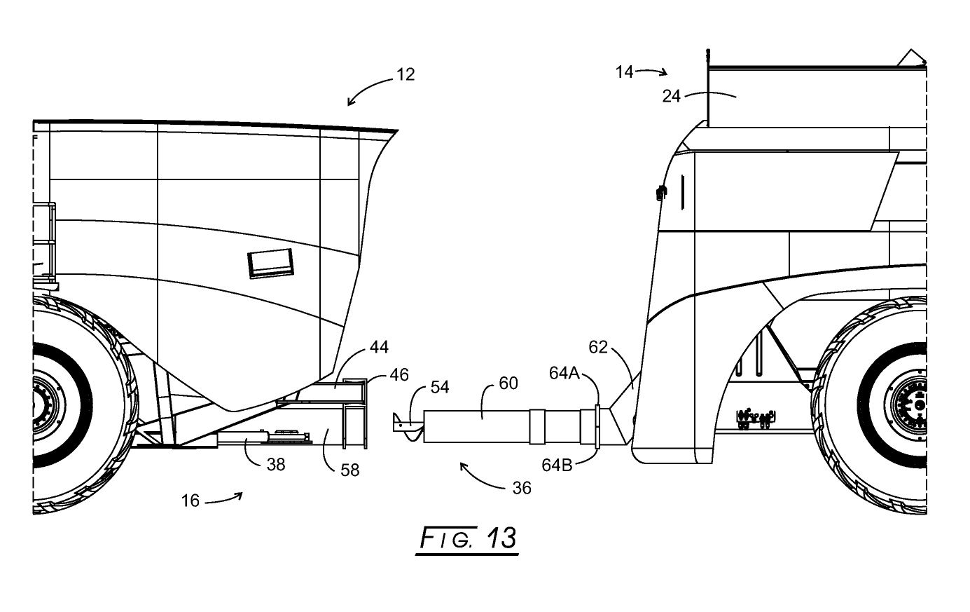

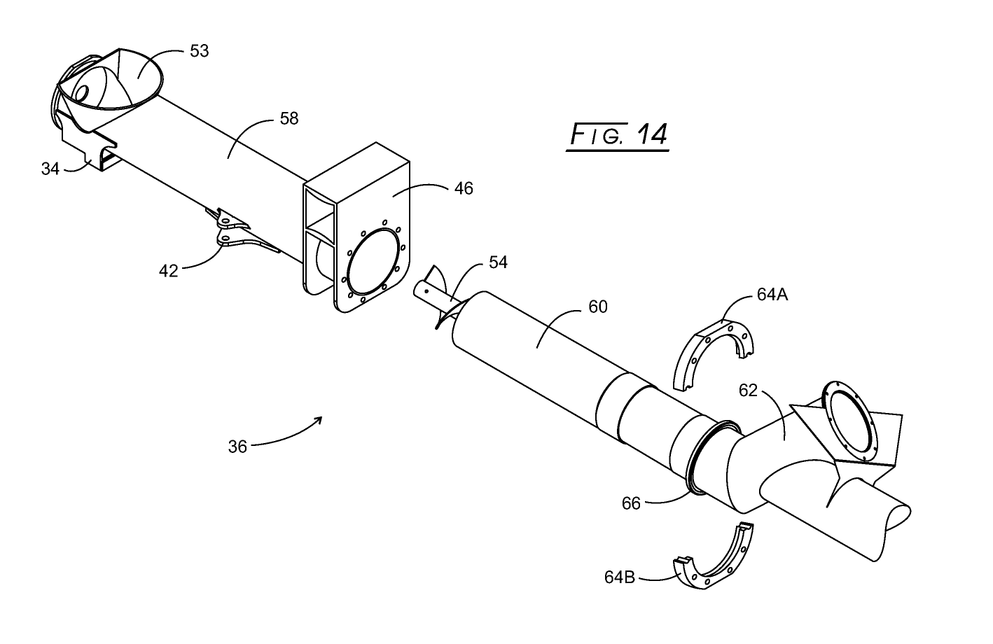

FIGS. 6A, 10, and 11 show grain auger assembly 36 being fed clean grain from a transverse auger assembly, 48, with the direction of travel of clean grain being indicated by the arrows. Transverse auger assembly 48 is composed of oppositely rotating auger sections, 48A and 48B (see FIGS. 10 and 11), located on a common shaft with opposed directing flighting that feed clean grain to the center of transverse auger assembly 48 where a pair of paddles, 37 and 39, where clean grain, then, is flung through a chute, 41, against an angled front wall, 50, that carries an impact sensor pad, 52, that measures the amount of grain impacting it. From impact sensor pad 52, the clean grain angles downwardly, as indicated by an arrow, through a funnel, 53 (see FIGS. 10 and 11), and into the initial flight of an auger, 54, rotating inside auger assembly 36 and powered by a hydraulic motor, 56. It is important that the clean grain enter grain auger tube 36 with sufficient velocity so that it will be moved by grain auger 56. A lid, 55, covers funnel 53. Lid 55 remains stationary with front module 12, while funnel 53 rotates with auger assembly 36 during turning of articulated combine 10 or when rear module 12 goes over uneven ground, such as is illustrated in FIGS. 11 and 12.

As best seen in FIG. 14, grain auger assembly 36 actually is composed of a pair of nested tubes, 58 and 60. Outer tube 58 is attached to sliding member 46 at one end and to forward module 12 at the other end. Inner tube 60 has one free end, while the other end is attached to an upwardly ascending auger assembly, 62, that transfers the clean grain into rear module 14. A pair of clamp rings, 64A and 64B, surround a flange, 66, at one end of inner tube 60. Clamp rings 64A and 64B bolt to sliding member 46. This arrangement permits inner tube 60 to rotate within outer tube 58 as rear module 12 moves over uneven ground without affecting any clean grain transfer between front module 12 and rear module 14, such as is illustrated in FIGS. 11 and 12.

While the apparatus and method have been described with reference to various embodiments, those skilled in the art will understand that various changes may be made and equivalents may be substituted for elements thereof without departing from the scope and essence of the disclosure. In addition, many modifications may be made to adapt a particular situation or material to the teachings of the disclosure without departing from the essential scope thereof. Therefore, it is intended that the disclosure not be limited to the particular embodiments disclosed, but that the disclosure will include all embodiments falling within the scope of the appended claims. In this application all units are in the metric system and all amounts and percentages are by weight, unless otherwise expressly indicated. Also, all citations referred herein are expressly incorporated herein by reference.

I claim:

1. In a grain harvesting articulated combine of a forward crop processing power unit (PPU), a rear grain cart, and an articulation joint that connects the PPU with the rear grain cart, the PPU having a front, a rear, and a centerline, the improved articulation joint, which comprises:
(a) a transverse drawbar attached to the PPU about the rear of the PPU and about the PPU centerline, said transverse drawbar having an aperture facing the rear grain cart, said transverse drawbar being located underneath the PPU forwardly of the rear of the powered PPU;
(b) an arcuate beam attached to the rear of the PPU;
(c) a grain auger assembly running from the PPU to the rear grain cart for transferring clean grain to the rear grain cart and having a forward end and a rear end adjacent to the rear grain cart, the grain auger assembly formed from an outer tube and an inner tube rotatingly carried within the outer tube;
(d) a bracket affixed to the forward end of the grain auger assembly outer tube, the bracket having an aperture;
(e) a pin running through the transverse drawbar aperture and through the bracket aperture;
(f) a pair of articulation cylinders affixed to the transverse drawbar and to the grain auger assembly outer tube; and
(g) a sliding member slidably carried by the arcuate beam and affixed to the grain auger assembly outer tube.

2. The grain harvesting articulated combine of claim 1, wherein said pin is located about the center of the PPU

3. The grain harvesting articulated combine of claim 1, further comprising:
(h) a transverse auger assembly having a center carrying paddles and having opposite flights on either side of the center for receiving clean grain and moving the clean grain to the transverse auger assembly;
(i) a chute for receiving clean grain from the paddles; and
(j) an angled front wall that carries an impact sensor pad that measures the amount of grain impacting it, said chute directing clean grain from the paddles onto said impact sensor and into the a grain auger assembly.

4. In a grain harvesting articulated combine of a powered crop processing power unit (PPU), a rear grain cart, and an articulation joint that connects the PPU with the rear grain cart, the PPU having a front, a rear, and a centerline, the improvement, which comprises:
(a) a grain auger assembly running from the PPU to the rear grain cart for transferring clean grain to the rear grain cart, the grain auger assembly having a forward end at the PPU having an aperture for receiving clean grain and a rear end at the grain cart, the grain auger assembly located in a tube running from the PPU to the rear grain cart;
(b) an angled wall carrying an impact sensor pad for measuring the amount of grain impacting the impact sensor pad; and
(c) a transverse paddled auger assembly feeding grain downwardly from the paddles to the angled wall impact sensor located above the grain auger forward end aperture and into the grain auger forward end aperture.

5. The grain harvesting articulated combine of claim 4, further comprising:
(d) a chute located between the transverse paddled auger assembly and the impact sensor pad for directing clean grain from the paddles and onto the sensor pad.

6. The grain harvesting articulated combine of claim 4, wherein the transverse paddled auger assembly has a common shaft with oppositely rotating auger sections to about the center of the shaft whereat the paddles are located.

7. In a grain harvesting articulated combine of a powered crop processing power unit (PPU), a rear grain cart, and an articulation joint that connects the PPU with the rear grain cart, the PPU having a front, a rear, and a centerline, the improvement, which comprises:
a grain auger assembly running from the PPU to the rear grain cart for transferring clean grain to the rear grain cart, the grain auger assembly having a forward end attached to the PPU, having an aperture below the PPU for receiving clean grain, and having a rearward end at the grain cart, the grain auger assembly located in a grain auger assembly tube running from the PPU to the rear grain cart; wherein the grain auger assembly is formed from an outer tube and an inner tube rotatingly carried within the outer tube.

8. The grain harvesting articulated combine of claim 7, wherein a pair of articulation cylinder assemblies are attached to the PUU and to the outer tube.

9. The grain harvesting articulated combine of claim 8, wherein an arcuate beam is attached to the rear of the PPU and to the outer tube.

10. In a grain harvesting articulated combine of a powered crop processing power unit (PPU), a rear grain cart, and an articulation joint that connects the PPU with the rear grain cart, the PPU having a front, a rear, and a centerline, the improvement, which comprises:
(a) a grain auger assembly including a grain auger housed within a grain auger tube running from the PPU to the grain cart for transferring clean grain from the PPU into the grain cart, the grain auger assembly including an outer tube and an inner tube rotatingly carried within the outer tube;
(b) an arcuate beam attached to the rear of the powered PPU; and
(c) a sliding member slidably carried by the arcuate beam and affixed to the grain auger assembly outer tube.

11. The grain harvesting articulated combine of claim 10, further comprising a grain auger assembly running from the PPU to the rear grain cart for transferring clean grain to the rear grain cart, the grain auger assembly having a forward end attached to the PPU, having an aperture below the PPU for receiving clean grain, and having a rearward end at the grain cart, the grain auger assembly located in a grain auger assembly tube running from the PPU to the rear grain cart; wherein the grain auger assembly is formed from an outer tube and an inner tube rotatingly carried within the outer tube.

12. The grain harvesting articulated combine of claim 11, wherein the arcuate beam also is attached to the outer tube.
